(19) United States
(12) Patent Application Publication
(10) Pub. No.: US 2008/0106143 A1
(43) Pub. Date: May 8, 2008

(54) BRAKE CONTROL APPARATUS AND METHOD

(75) Inventors: Manabu Yazaki, Toyota-shi (JP); Eiji Nakamura, Aichi-ken (JP); Takayuki Yamamoto, Aichi-ken (JP); Yasuji Mizutani, Brussels (BE)

Correspondence Address: OBLON, SPIVAK, MCCLELLAND MAIER & NEUSTADT, P.C., 1940 DUKE STREET, ALEXANDRIA, VA, 22314, US

(73) Assignee: TOYOTA JIDOSHA KABUSHIKI KAISHA, Toyota-shi (JP)

(21) Appl. No.: 11/935,641

(22) Filed: Nov. 6, 2007

(30) Foreign Application Priority Data
Nov. 7, 2006 (JP) 2006-301205

(51) Int. Cl. B60T 15/16; B60T 13/122; B60L 7/22

(52) U.S. Cl. 303/13; 303/152; 701/70

(57) ABSTRACT

A brake control apparatus and method that reduces discomfort in a braking feel is provided. The brake control apparatus includes a wheel cylinder pressure control system that controls a hydraulic pressure applied to a wheel cylinder independently of an operation of a brake pedal; and a manual hydraulic pressure source that pressurizes a hydraulic fluid in accordance with the operation amount of the brake pedal. The wheel cylinder pressure control system and the manual hydraulic pressure source are in parallel with each other, and connected to the wheel cylinder. In the case where the wheel cylinder pressure is controlled by the wheel cylinder pressure control system, when the hydraulic pressure in the manual hydraulic pressure source is equal to or higher than the hydraulic pressure in the wheel cylinder, the hydraulic fluid is supplied from the manual hydraulic pressure source to the wheel cylinder.

### INCORPORATION BY REFERENCE

This disclosure of Japanese Patent Application No. 2006-301205, filed on Nov. 7, 2006, including the specification, drawings, and abstract is incorporated by reference in its entirety.

### BACKGROUND OF THE INVENTION

1. Field of the Invention

The invention relates to a brake control apparatus and method for controlling a braking force applied to the wheels of a vehicle.

2. Description of the Related Art

Japanese Patent Application Publication No. 2006-123889 (JP-A-2006-123889) describes a hydraulic brake apparatus including a hydraulic pressure booster, a master cylinder, a power hydraulic pressure source and multiple brake cylinders. In this hydraulic brake apparatus, the multiple brake cylinders may be selectively communicated with the hydraulic pressure booster, the master cylinder and the power hydraulic pressure source using a simple circuit. This structure provides greater control over a hydraulic pressure. In this hydraulic brake apparatus, a cooperative braking control is executed, that is, a regenerative brake and a hydraulic brake are used in cooperation to generate a required braking force. In this case, the hydraulic fluid is usually supplied from the power hydraulic pressure source to the brake cylinders. Instead of this control mode in which the hydraulic fluid is supplied from the power hydraulic pressure source to the brake cylinders, another control mode may be selected to generate a braking force. In this hydraulic brake apparatus, the control modes are changed depending on the situation. When the control modes are changed, the open/close states of multiple control valves in the hydraulic brake apparatus are changed.

When the hydraulic pressure source is changed from the power hydraulic pressure source to another hydraulic pressure source, the wheel cylinder pressure may be decreased due to the pressure difference between the upstream side and downstream side of the control valve, which causes the driver to feel some discomfort in a braking feel. For example, when the vehicle is decelerating, the driver may feel that the magnitude of deceleration is reduced (i.e., the driver may feel that the vehicle does not decelerate as hard as he/she expected). When the vehicle is stopped on an uphill slope, the vehicle may start moving.

### SUMMARY OF THE INVENTION

The invention provides a brake control apparatus and method that reduces discomfort in a braking feel which may be caused when the control mode is changed.

An aspect of the invention relates to a brake control apparatus including: a wheel cylinder that applies a braking force to a wheel of a vehicle in response to a supply of a hydraulic fluid to the wheel cylinder; a wheel cylinder pressure control system that controls a hydraulic pressure applied to the wheel cylinder independently of an operation of a brake pedal; a manual hydraulic pressure source that pressurizes a hydraulic fluid which is stored in the manual hydraulic pressure source in accordance with the operation amount of the brake pedal; a hydraulic fluid supply path that connects the manual hydraulic pressure source and the wheel cylinder to each other, that extends in parallel with the wheel cylinder pressure control system, and that is shut off when the hydraulic pressure applied to the wheel cylinder is controlled by the wheel cylinder pressure control system; and a control unit. In the case where the hydraulic pressure applied to the wheel cylinder is controlled by the wheel cylinder pressure control system such that a hydraulic pressure in the wheel cylinder corresponds to a hydraulic pressure in the manual hydraulic pressure source, when the condition that the hydraulic pressure in the manual hydraulic pressure source is equal to or higher than the hydraulic pressure in the wheel cylinder is satisfied, the control unit terminates the control executed by the wheel cylinder pressure control system, and controls the hydraulic fluid supply path such that the hydraulic fluid is supplied from the manual hydraulic pressure source to the wheel cylinder.

According to the aspect of the invention described above, when the hydraulic pressure in the manual hydraulic pressure source is equal to or higher than the hydraulic pressure in the wheel cylinder, the control mode is changed from the control mode in which the hydraulic pressure applied to the wheel cylinder is controlled by the wheel cylinder pressure control system to the control mode in which the hydraulic fluid is supplied from the manual hydraulic pressure source to the wheel cylinder. Because the hydraulic pressure in the manual hydraulic pressure source is equal to or higher than the hydraulic pressure in the wheel cylinder, the situation does not occur in which the hydraulic fluid flows back from the wheel cylinder to the manual hydraulic pressure source when the control mode is changed and therefore the wheel cylinder pressure is decreased. Accordingly, even if the control mode is changed, for example, while the vehicle is stopped on a slope, occurrence of the situation in which the vehicle moves downward due to a reduction in the braking force is minimized. In addition, even if the control mode is changed while the vehicle is moving, discomfort in a braking feel is suppressed.

The brake control apparatus according to the aspect of the invention described above may further include a manual hydraulic pressure sensor that detects the hydraulic pressure in the manual hydraulic pressure source; and a wheel cylinder pressure sensor that detects the hydraulic pressure in the wheel cylinder. The control unit may determine that the condition that the hydraulic pressure in the manual hydraulic pressure source is equal to or higher than the hydraulic pressure in the wheel cylinder is satisfied, when the hydraulic pressure difference, which is obtained by subtracting the hydraulic pressure detected by the wheel cylinder pressure sensor from the hydraulic pressure detected by the manual hydraulic pressure sensor, is equal to or greater than a threshold value. In this way, it is possible to reliably determine whether the hydraulic pressure in the manual hydraulic pressure source is higher than the hydraulic pressure in the wheel cylinder by appropriately set the predetermined value as a margin.

The brake control apparatus according to the aspect of the invention described above may further include a pressure-decreasing control valve that decreases the hydraulic pressure in the wheel cylinder. The control unit may control the pressure-decreasing control valve to decrease the hydraulic pressure in the wheel cylinder until it is determined that the hydraulic pressure in the manual hydraulic pressure source is equal to or higher than the hydraulic pressure in the wheel cylinder. With this configuration, the wheel cylinder pressure is actively decreased such that the hydraulic pressure in the manual hydraulic pressure source is equal to or higher than the hydraulic pressure in the wheel cylinder. Thus, it is possible to change the control modes without decreasing the wheel cylinder pressure.

In the brake control apparatus according the aspect of the invention described above, the control unit may control the hydraulic fluid supply path such that the hydraulic fluid is supplied from the manual hydraulic pressure source to the wheel cylinder, when the brake pedal is depressed again while the vehicle is stopped. With this configuration, it is possible to change the control modes based on the operation of the brake pedal without decreasing the wheel cylinder pressure. This is because, when the brake pedal is depressed again while the vehicle is stopped, it is estimated that the hydraulic pressure in the manual hydraulic pressure source is equal to or higher than the hydraulic pressure in the wheel cylinder.

In the brake control apparatus according to the aspect of the invention described above, the control unit may resume the control mode in which the hydraulic pressure applied to the wheel cylinder is controlled by the wheel cylinder pressure control system, when the condition for permitting a regenerative braking control is satisfied. With this configuration, only when the condition for permitting the regenerative braking control is satisfied, the control mode in which the hydraulic pressure applied to the wheel cylinder is controlled by the wheel cylinder pressure control system is resumed. Therefore, the frequency at which the control mode is changed is reduced.

In the brake control apparatus according to the aspect of the invention described above, the regenerative braking control is able to be executed, the hydraulic fluid may be supplied from the manual hydraulic pressure source to the wheel cylinder while the vehicle is stopped, the hydraulic pressure applied to the wheel cylinder may be controlled by the wheel cylinder pressure control system when the vehicle is moving, the hydraulic fluid may be supplied from the manual hydraulic pressure source to the wheel cylinder when the vehicle starts moving after being once stopped, and the control mode may be changed to the control mode in which the hydraulic pressure applied to the wheel cylinder is controlled by the wheel cylinder pressure control system, when the regenerative braking control is started.

In the brake control apparatus according to the aspect of the invention described above, the threshold value may be set based on a detection error in the hydraulic pressure in the manual hydraulic pressure source and a detection error in the hydraulic pressure in the wheel cylinder.

In the brake control apparatus according to the aspect of the invention described above, the control unit may determine whether the hydraulic pressure in the manual hydraulic pressure source is equal to or higher than the hydraulic pressure in the wheel cylinder, when a required braking force has not been increased.

In the brake control apparatus according to the aspect of the invention described above, the control unit may control the hydraulic fluid supply path such that the hydraulic fluid is supplied from the manual hydraulic pressure source to the wheel cylinder, when a degree of depression of the brake pedal is reduced.

In the brake control apparatus according to the aspect of the invention described above, whether the condition for permitting the regenerative braking control is satisfied may be determined based on the vehicle speed or the state of charge of a battery that stores regenerated energy.

In the brake control apparatus according to the aspect of the invention described above, the wheel cylinder pressure control system may include a normally-closed control valve, and the control unit may shut off a supply of control current to the normally-closed control valve, thereby controlling the hydraulic fluid supply path such that the hydraulic fluid is supplied from the manual hydraulic pressure source to the wheel cylinder.

According to the invention, it is possible to reduce discomfort in a braking feel.

### BRIEF DESCRIPTION OF THE DRAWINGS

The above and other features and advantages of the invention will become apparent from the following description of an example embodiment, given in conjunction with the accompanying drawings, in which:

FIG. 1 is a system diagram showing a brake control apparatus according to an embodiment of the invention;

FIG. 2 is a flowchart showing the control routine according to the embodiment of the invention;

FIG. 3 is a flowchart showing the pressure decreasing routine according to the embodiment of the invention; and

FIG. 4 is a flowchart showing an example of the routine for resuming the linear control mode according to the embodiment of the invention.

### DETAILED DESCRIPTION OF THE EMBODIMENT

Hereafter, an embodiment of the invention will be described in detail with reference to the accompanying drawings.

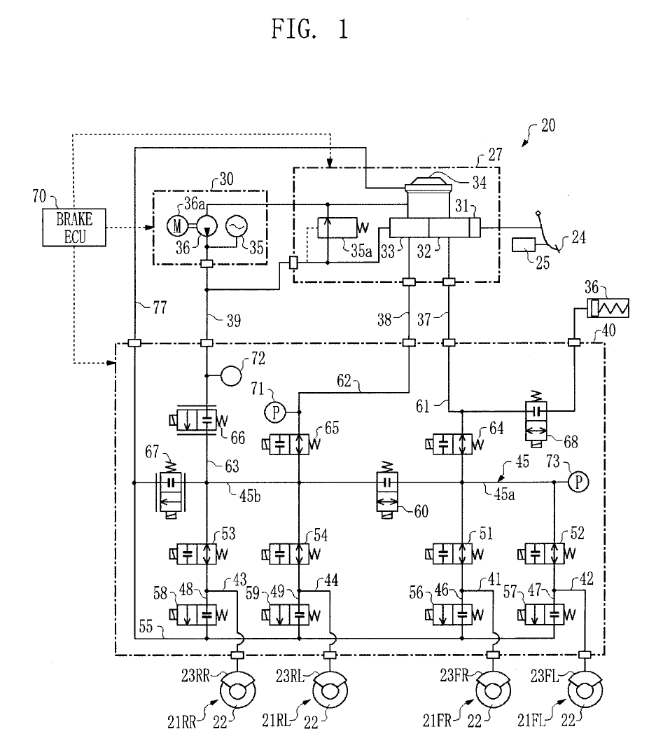

FIG. 1 is a system diagram showing a brake control apparatus 20 according to an embodiment of the invention. The brake control apparatus 20 shown in FIG. 1 forms an electronically-controlled brake system (ECB) for a vehicle, and controls braking forces applied to the four wheels of the vehicle. The brake control apparatus 20 according to the embodiment of the invention may be mounted in, for example, a hybrid vehicle which includes an electric motor and an internal combustion engine as drive power sources. In such hybrid vehicle, each of the regenerative braking control, in which the vehicle speed is reduced by converting some of kinetic energy of the vehicle into electrical energy, and the hydraulic braking control, in which the vehicle speed is reduced using the brake control apparatus 20, may be executed. In the vehicle in the embodiment of the invention, the cooperative braking control may be executed. In the cooperative braking control, the regenerative braking control and the hydraulic braking control are executed in combination to generate a required braking force.

As shown in FIG. 1, the brake control apparatus 20 includes disk brake units 21FR, 21FL, 21RR and 21RL provided to the respective wheels, a master cylinder unit 27, a power hydraulic pressure source 30 and a hydraulic pressure actuator 40.

The disk brake units 21FR, 21FL, 21RR and 21RL apply braking forces to the front-right wheel, the front-left wheel, the rear-right wheel and the rear-left wheel, respectively. The master cylinder unit 27, which functions as a manual hydraulic pressure source according to the invention, sends, to the disk brake units 21FR to 21RL, the brake fluid that is pressurized in accordance with the amount by which the driver has operated a brake pedal 24 that serves as a brake operation member. The power hydraulic pressure source 30 is able to send, to the disk brake units 21FR to 21RL, the brake fluid, which is the hydraulic fluid pressurized due to a power supplied thereto, independently of the operation of the brake pedal 24 performed by the driver. The hydraulic pressure actuator 40 appropriately adjusts the hydraulic pressure of the brake fluid that is supplied from the power hydraulic pressure source 30 or the master cylinder unit 27, and then sends the brake fluid to the disk brake units 21FR to 21RL. With this structure, the braking forces that will be applied to the respective wheels by hydraulic braking are appropriately adjusted.

The disk brake units 21FR to 21RL, the master cylinder unit 27, the power hydraulic pressure source 30 and the hydraulic pressure actuator 40 will be described below in detail. The disk brake units 21FR, 21FL, 21RR and 21RL include brake disks 22 and wheel cylinders 23FR, 23FL, 23RR and 23RL housed in brake calipers, respectively. The wheel cylinders 23FR to 23RL are connected to the hydraulic pressure actuator 40 through respective fluid passages. Hereinafter, the wheel cylinders 23FR to 23RL will be collectively referred to as the “wheel cylinders 23” where appropriate.

In each of the disk brake units 21FR to 21RL, when the brake fluid from the hydraulic pressure actuator 40 is supplied to the wheel cylinder 23, a brake pad, which serves as a friction member, is pushed against the brake disk 22 that rotates together with the wheel. As a result, a braking force is applied to the wheel. In the embodiment of the invention, the disk brake units 21FR to 21RL are used. Alternatively, another type of braking force application mechanisms including wheel cylinders, for example, drum brakes may be used.

The master cylinder unit 27 used in the embodiment of the invention mainly includes a master cylinder with a hydraulic pressure booster. The master cylinder unit 27 includes a hydraulic pressure booster 31, a master cylinder 32, a regulator 33 and a reservoir 34. The hydraulic pressure booster 31 is connected to the brake pedal 24, and amplifies a pedal depressing force applied to the brake pedal 24 and then transfers the amplified force to the master cylinder 32. The brake fluid is supplied from the power hydraulic pressure source 30 to the hydraulic pressure booster 31 via the regulator 33, whereby the pedal depressing force is amplified. The master cylinder 32 generates a master cylinder pressure having a predetermined boost ratio with respect to the pedal depressing force.

The reservoir 34 that stores the brake fluid is provided on the master cylinder 32 and the regulator 33. The master cylinder 32 is communicated with the reservoir 34 when the brake pedal 24 is released. The regulator 33 is communicated with both the reservoir 34 and an accumulator 35 of the power hydraulic pressure source 30. The regulator 33 generates a hydraulic pressure that is substantially equal to the master cylinder pressure, using the reservoir 34 as a low pressure source, and the accumulator 35 as a high pressure source. Hereinafter, the hydraulic pressure in the regulator 33 will be referred to as the “regulator pressure” where appropriate. The master cylinder pressure and the regulator pressure need not be exactly equal to each other. For example, the master cylinder unit 27 may be designed such that the regulator pressure is slightly higher than the master cylinder pressure.

The power hydraulic pressure source 30 includes the accumulator 35 and a pump 36. The accumulator 35 converts the pressure energy of the brake fluid boosted by the pump 36 into pressure energy of a filler gas such as nitrogen, for example, pressure energy of approximately 14 MPa to approximately 22 MPa, and accumulates the converted pressure energy. The pump 36 is provided with a motor 36a that is used as a drive power source. The inlet of the pump 36 is connected to the reservoir 34, and the outlet of the pump 36 is connected to the accumulator 35. The accumulator 35 is also connected to a relief valve 35a included in the master cylinder unit 27. When the pressure of the brake fluid in the accumulator 35 is increased to an excessively high pressure, for example, approximately 25 MPa, the relief valve 35a opens and the brake fluid having such excessively high pressure is returned to the reservoir 34.

As described above, the brake control apparatus 20 includes the master cylinder 32, the regulator 33 and the accumulator 35 that serve as the source that supplies brake fluid to the wheel cylinder 23. A master conduit 37 is connected to the master cylinder 32, a regulator conduit 38 is connected to the regulator 33, and an accumulator conduit 39 is connected to the accumulator 35. The master conduit 37, regulator conduit 38 and accumulator conduit 39 are connected to the hydraulic pressure actuator 40.

The hydraulic pressure actuator 40 includes an actuator block in which multiple fluid passages are formed, and multiple electromagnetically-controlled valves. The multiple fluid passages formed in the actuator block include individual fluid passages 41, 42, 43, and 44, and a main fluid passage 45. The individual fluid passages 41, 42, 43 and 44 branch off from the main fluid passage 45, and are connected to the wheel cylinders 23FR, 23FL, 23RR, and 23RL of the disk brake units 21FR, 21FL, 21RR, and 21RL, respectively. With this structure, each wheel cylinder 23 may communicate with the main fluid passage 45.

ABS holding valves 51, 52, 53 and 54 are provided at the middle portions of the individual fluid passages 41, 42, 43, and 44, respectively. Each of the ABS holding valves 51 to 54 includes an ON/OFF solenoid valve, and a spring. Each of the ABS holding valves 51 to 54 is a normally-open electromagnetically-controlled valve that is open when electricity is not supplied to the solenoid valve. When the ABS holding valves 51 to 54 are open, the brake fluid is allowed to flow from the main passage 45 to the wheel cylinders 23, or from the wheel cylinders 23 to the main passage 45. When the solenoid valves are supplied with electricity and the ABS holding valves 51 to 54 are closed, flows of the brake fluid through the individual fluid passages 41 to 44 are shut off.

The wheel cylinders 23 are connected to a reservoir fluid passage 55 through pressure-decreasing fluid passages 46, 47, 48 and 49 connected to the respective individual fluid passages 41, 42, 43 and 44. ABS pressure-decreasing valves 56, 57, 58 and 59 are provided at the middle portions of the pressure-decreasing fluid passages 46, 47, 48 and 49, respectively. Each of the ABS pressure-decreasing valves 56 to 59 includes an ON/OFF solenoid valve, and a spring. Each of the ABS pressure-decreasing valves 56 to 59 is a normally-closed electromagnetically-controlled valve that is closed when electricity is not supplied to the solenoid valve. When the ABS pressure-decreasing valves 56 to 59 are closed, flows of the brake fluid through the pressure-decreasing fluid passages 46 to 49 are shut off. When electricity is supplied to the solenoid valves, and the ABS pressure-decreasing valves 56 to 59 are open, the brake fluid is allowed to flow through the pressure-decreasing fluid passages 46 to 49. As a result, the brake fluid flows back from the wheel cylinders 23 to the reservoir 34 through the pressure-decreasing fluid passages 46 to 49 and the reservoir fluid passage 55. The reservoir fluid passage 55 is connected to the reservoir 34 of the master cylinder unit 27 through a reservoir conduit 77.

A partition valve 60 is provided at the middle portion of the main fluid passage 45. The partition valve 60 partitions the main fluid passage 45 into a first fluid passage 45a connected to the individual fluid passages 41 and 42, and a second fluid passage 45b connected to the individual fluid passages 43 and 44. The first fluid passage 45a is connected to the wheel cylinders 23FR and 23FL of the front wheels via the individual fluid passages 41 and 42, respectively. The second fluid passage 45b is connected to the wheel cylinders 23RR and 23RL of the rear wheels via the individual fluid passages 43 and 44, respectively.

The partition valve 60 includes an ON/OFF solenoid valve, and a spring. The partition valve 60 is a normally-closed electromagnetically-controlled valve which is closed when electricity is not supplied to the solenoid valve. When the partition valve 60 is closed, a flow of the brake fluid through the main fluid passage 45 is shut off. When electricity is supplied to the solenoid valve, and the partition valve 60 is open, the brake fluid is allowed to flow from the first fluid passage 45a to the second fluid passage 45b, or from the second fluid passage 45b to the first fluid passage 45a.

A master fluid passage 61 and a regulator fluid passage 62, which are communicated with the main fluid passage 45, are formed in the hydraulic pressure actuator 40. More specifically, the master fluid passage 61 is connected to the first fluid passage 45a of the main fluid passage 45, and the regulator fluid passage 62 is connected to the second fluid passage 45b of the main fluid passage 45. The master fluid passage 61 is connected to the master conduit 37 communicated with the master cylinder 32. The regulator fluid passage 62 is connected to the regulator conduit 38 communicated with the regulator 33.

A master cut valve 64 is provided at the middle portion of the master fluid passage 61. The master cut valve 64 is provided on the path through which the brake fluid is supplied from the master cylinder 32 to the wheel cylinders 23. The master cut valve 64 includes an ON/OFF solenoid valve, and a spring. The master cut valve 64 is a normally-open electromagnetically-controlled valve that is kept closed by the electromagnetic force generated by the solenoid valve upon reception of a prescribed magnitude of control current, and that is open when electricity is not supplied to the solenoid valve. When the master cut valve 64 is open, the brake fluid is allowed to flow from the master cylinder 32 to the first fluid passage 45a of the main fluid passage 45, or from the first fluid passage 45a to the master cylinder 32. When the prescribed magnitude of control current is supplied to the solenoid valve and the master cut valve 64 is closed, a flow of the brake fluid through the master fluid passage 61 is shut off.

A stroke simulator 69 is connected to the master fluid passage 61 via a simulator cut valve 68, at a position upstream of the master cut valve 64. That is, the simulator cut valve 68 is provided on the fluid passage that connects the master cylinder 32 and the stroke simulator 69 to each other. The simulator cut valve 68 includes an ON/OFF solenoid valve, and a spring. The simulator cut valve 68 valve is a normally-closed electromagnetically-controlled valve that is kept open by the electromagnetic force generated by the solenoid valve upon reception of a prescribed magnitude of control current, and that is closed when electricity is not supplied to the solenoid valve. When the simulator cut valve 68 is closed, a flow of the brake fluid between the master passage 61 and the stroke simulator 69 is shut off. When electricity is supplied to the solenoid valve, and the simulator cut valve 68 is open, the brake fluid is allowed to flow from the master cylinder 32 to the stroke simulator 69, or from the stroke simulator 69 to the master cylinder 32.

The stroke simulator 69 includes multiple pistons and springs. The stroke simulator 69 generates a reaction force corresponding to the pedal depressing force applied to the brake pedal 24 by the driver, when the simulator cut valve 68 is open. To improve the brake operating feel felt by the driver, preferably, a stroke simulator having multi-stage spring characteristics is employed as the stroke simulator 69.

A regulator cut valve 65 is provided at the middle portion of a regulator fluid passage 62. The regulator cut valve 65 is provided on the path through which the brake fluid is supplied from the regulator 33 to the wheel cylinders 23. The regulator cut valve 65 also includes an ON/OFF solenoid valve, and a spring. The regulator cut valve 65 is a normally-open electromagnetically-controlled valve that is kept closed by the electromagnetic force generated by the solenoid valve upon reception of a prescribed magnitude of control current, and that is open when electricity is not supplied to the solenoid valve. When the regulator cut valve 65 is open, the brake fluid is allowed to flow from the regulator 33 to the second fluid passage 45b of the main fluid passage 45, or from the second fluid passage 45b to the regulator 33. When electricity is supplied to the solenoid valve and the regulator cut valve 65 is closed, a flow of the brake fluid through the regulator fluid passage 62 is shut off.

In addition to the master fluid passage 61 and the regulator fluid passage 62, an accumulator fluid passage 63 is also formed in the hydraulic pressure actuator 40. One end of the accumulator fluid passage 63 is connected to the second fluid passage 45b of the main fluid passage 45, and the other end thereof is connected to the accumulator conduit 39 that is communicated with the accumulator 35.

A pressure-increasing linear control valve 66 is provided at the middle portion of the accumulator fluid passage 63. The accumulator fluid passage 63 and the second fluid passage 45b of the main fluid passage 45 are connected to a reservoir fluid passage 55 via a pressure-decreasing linear control valve 67. Each of the pressure-increasing linear control valve 66 and the pressure-decreasing linear control valve 67 includes a solenoid valve and a spring. Each of the pressure-increasing linear control valve 66 and the pressure-decreasing linear control valve 67 is a normally-closed electromagnetically-controlled valve that is closed when electricity is not supplied to the solenoid valve. The opening amount of each of the pressure-increasing linear control valve 66 and the pressure-decreasing linear control valve 67 is adjusted in proportion to the magnitude of electric current supplied to the solenoid valve.

The pressure-increasing linear control valve 66 is a pressure-increasing control valve shared by all the multiple wheel cylinders 23 corresponding to the respective wheels. Similarly, the pressure-decreasing linear valve 67 is a pressure-decreasing control valve shared by all the multiple wheel cylinders 23. In the embodiment of the invention, the pressure-increasing linear control valve 66 and the pressure-decreasing linear control valve 67 serve as paired control valves that control the manner in which the hydraulic fluid from the power hydraulic pressure source 30 is supplied to the wheel cylinders 23. The cost performance is better when a linear control valve, for example, the pressure-increasing control valve 66 is shared by all the wheel cylinders 23 than when the wheel cylinder 23 are provided with respective linear control valves.

The pressure difference between the inlet and the outlet of the pressure-increasing linear control valve 66 corresponds to the pressure difference between the brake fluid in the accumulator 35 and the brake fluid in the main fluid passage 45. The pressure difference between the inlet and the outlet of the pressure-decreasing linear control valve 67 corresponds to the pressure difference between the brake fluid in the main fluid passage 45 and the brake fluid in the reservoir 34. When the electromagnetic driving force that corresponds to the electricity supplied to the linear solenoid valve of each of the pressure-increasing linear control valve 66 and the pressure-decreasing linear control valve 67 is denoted by F1, the biasing force of the spring is denoted by F2, and the pressure difference between the inlet and the outlet of each of the pressure-increasing linear control valve 66 and the pressure-decreasing linear control valve 67 is denoted by F3, the relationship among F1, F2 and F3 is expressed by the equation, F1+F3=F2. Accordingly, the pressure difference between the inlet and the outlet of each of the pressure-increasing linear control valve 66 and the pressure-decreasing linear control valve 67 is controlled by continuously controlling of the electricity supplied to the linear solenoid valve of each of the pressure-increasing linear control valve 66 and the pressure-decreasing linear control valve 67.

In the brake control apparatus 20, the power hydraulic pressure source 30 and the hydraulic pressure actuator 40 are controlled by a brake ECU 70 that functions as a control unit according to the invention. The brake ECU 70 is formed of a microprocessor including a CPU. The brake ECU 70 includes ROM that stores various programs, RAM that temporarily stores data, an input port, an output port, a communication port, etc. in addition to the CPU. The brake ECU 70 is able to communicate with, for example, a hybrid ECU (not shown), which is at a higher-level hierarchy. The brake ECU 70 controls the pump 36 of the power hydraulic pressure source 30 and the electromagnetically-controlled valves 51 to 54, 56 to 59, 60, and 64 to 68 included in the hydraulic pressure actuator 40, based on control signals from the hybrid ECU and signals from various sensors.

A regulator pressure sensor 71, an accumulator pressure sensor 72 and a control pressure sensor 73 are connected to the brake ECU 70. The regulator pressure sensor 71 detects the pressure of the brake fluid in the regulator fluid passage 62, i.e., the regulator pressure, at a position upstream of the regulator cut valve 65, and transmits a signal indicating the detected regulator pressure to the brake ECU 70. The accumulator pressure sensor 72 detects the pressure of the brake fluid in the accumulator fluid passage 63, i.e., the accumulator pressure, at a position upstream of the pressure-increasing linear control valve 66, and transmits a signal indicating the detected accumulator pressure to the brake ECU 70. The control pressure sensor 73 detects the pressure of the brake fluid in the first fluid passage 45a of the main fluid passage 45, and transmits a signal indicating the detected pressure to the brake ECU 70. The signals indicating the pressures detected by the pressure sensors 71 to 73 are transmitted to the brake ECU 70 at predetermined time intervals. Each time the brake ECU 70 receives the signal, the information indicated by the signal is stored in a certain memory region of the brake ECU 70.

When the partition valve 60 is open and therefore the first fluid passage 45a and second fluid passage 45b of the main fluid passage 45 are communicated with each other, the output value from the control pressure sensor 73 indicates the hydraulic pressure on the lower-pressure side of the pressure-increasing linear control valve 66 and, at the same time, indicates the hydraulic pressure on the higher-pressure side of the pressure-decreasing linear control valve 67. Therefore, the output value from the control pressure sensor 73 may be used to control the pressure-increasing linear control valve 66 and the pressure-decreasing linear control valve 67. When the pressure-increasing linear control valve 66 and the pressure-decreasing linear control valve 67 are closed and the master cut valve 64 is open, the output value from the control pressure sensor 73 indicates the master cylinder pressure. When the partition valve 60 is open to provide communication between the first fluid passage 45a and the second fluid passage 45b of the main fluid passage 45, the ABS holding valves 51 to 54 are open, and the ABS pressure-decreasing valves 56 to 59 are closed, the output value from the control pressure sensor 73 indicates the hydraulic pressure applied to each wheel cylinder 23, i.e., the wheel cylinder pressure.

In addition to the sensors described above, a stroke sensor 25 provided to the brake pedal 24 is connected to the brake ECU 70. The stroke sensor 25 detects the pedal stroke when the brake pedal 24 is depressed, and transmits a signal indicating the detected pedal stroke to the brake ECU 70. The signal indicating the pedal stroke detected by the stroke sensor 25 is transmitted to the brake ECU 70 at predetermined time intervals. Each time the brake ECU 70 receives the signal, the information indicated by the signal is stored in a certain memory region of the brake ECU 70. Brake operation state detection means other than the stroke sensor 25 may be provided in addition to or instead of the stroke sensor 25, and may be connected to the brake ECU 70. The brake operation state detection means may be, for example, a pedal depressing force sensor that detects the depressing force applied to the brake pedal 24, or a brake switch that detects depression of the brake pedal 24.

The brake control apparatus 20 configured as described above is able to execute the cooperative braking control. The brake control apparatus 20 starts the braking operation upon reception of a braking command. A braking command is issued when a braking force should be applied to the vehicle, for example, when the driver depresses the brake pedal 24. The brake ECU 70 calculates the required braking force upon reception of a braking command. The brake ECU 70 calculates the required hydraulic braking force, that is, the braking force that should be generated by the brake control apparatus 20, by subtracting the regenerative braking force from the required braking force. In this case, a signal indicating the regenerative braking force is transmitted from the hybrid ECU to the brake control apparatus 20. The brake ECU 70 calculates target hydraulic pressures for the wheel cylinders 23FR to 23RL based on the required hydraulic braking force derived through the calculation. The brake ECU 70 sets the values of the control currents supplied to the pressure-increasing linear control valve 66 and the pressure-decreasing linear control valve 67 based on a feedback control law such that the wheel cylinder pressures match the target hydraulic pressures.

As a result, in the brake control apparatus 20, the brake fluid is supplied from the power hydraulic pressure source 30 to the wheel cylinder 23 via the pressure-increasing linear control valve 66, and the braking forces are applied to the wheels. In addition, the brake fluid is discharged, as required, from the wheel cylinders 23 via the pressure-decreasing linear control valve 67, to adjust the braking forces applied to the wheels. The power hydraulic pressure source 30, the pressure-increasing linear control valve 66, the pressure-decreasing linear control valve 67, etc. constitute a wheel cylinder pressure control system according to the invention. With the wheel cylinder pressure control system, so-called brake-by-wire control is executed over a braking force. The wheel cylinder pressure control system is provided in parallel to the path through which the brake fluid is supplied from the master cylinder unit 27 to the wheel cylinders 23.

When the braking force is controlled by the wheel cylinder pressure control system, the brake ECU 70 closes the regulator cut valve 65 so that the brake fluid delivered from the regulator 33 is not supplied to the wheel cylinders 23. In addition, the brake ECU 70 closes the master cut valve 64 and opens the simulator cut valve 68. Accordingly, the brake fluid, which is delivered from the master cylinder 32 in response to the operation of the brake pedal 24 performed by the driver, is supplied to the stroke simulator 69 without being supplied to the wheel cylinders 23. During the cooperative braking control, a pressure difference, which corresponds to the magnitude of regenerative braking force, is caused between upstream side and the downstream of each of the regulator cut valve 65 and the master cut valve 64.

The brake control apparatus 20 according to the embodiment of the invention is able to control the braking force using the wheel cylinder pressure control system, even when the required braking force is obtained only from the hydraulic braking force without using the regenerative braking force. For example, when the vehicle is stopped, the regenerative braking force cannot be generated. Hereinafter, the control mode in which the braking force is controlled by the wheel cylinder pressure control system will be referred to as the “linear control mode” where appropriate, regardless of whether the cooperative braking control is executed. This control mode is sometimes referred to as the “brake-by-wire control.”

When the required braking force is obtained only from the hydraulic braking force in the linear control mode, the brake ECU 70 executes the control using the regulator pressure or the master cylinder pressure as the target wheel cylinder pressure. In this case, however, it is not necessary to use the wheel cylinder pressure control system to supply the brake fluid to the wheel cylinders 23. This is because the required braking force can be generated if the master cylinder pressure or a regulator pressure, which is increased in accordance with the operation of the brake pedal 24 performed by the driver, is supplied to the wheel cylinders 23.

Accordingly, in the brake control apparatus 20, the brake fluid may be supplied from the regulator 33 to the wheel cylinders 23 while the vehicle is stopped. Hereinafter, the control mode in which the brake fluid is supplied from the regulator 33 to the wheel cylinders 23 will be referred to as the “regulator mode”. The brake ECU 70 may change the control mode from the linear control mode to the regulator control mode and the braking force may be generated in the regulator mode while the vehicle is stopped. If the control mode is changed to the regulator mode at the same time that the vehicle is stopped, the control mode is changed by a relatively simple control. More practically, the brake ECU 70 may change the control mode from the linear control mode to the regulator mode, when the regenerative braking control is terminated because the vehicle speed has been decreased sufficiently by the braking operation.

In the regulator mode, the brake ECU 70 opens the regulator cut valve 65 and the partition valve 60, and closes the master cut valve 64. The controls over the pressure-increasing linear control valve 66 and the pressure-decreasing linear control valve 67 are terminated and thus these valves are closed. The simulator cut valve 68 is opened. As a result, the brake fluid is supplied from the regulator 33 to the wheel cylinders 23, and the braking forces are applied to the wheels by the regulator pressure. Because the power hydraulic pressure source 30, which serves as the high pressure source, is connected to the regulator 33, the regulator is able to generate a braking force using the pressure accumulated in the power hydraulic pressure source 30.

In the regulator mode described above, the brake ECU 70 shuts off the supply of control currents to the pressure-increasing linear control valve 66 and the pressure-decreasing linear control valve 67 to close these valves. As a result, these valves are brought into the non-operating state. Therefore, the pressure-increasing linear control valve 66 and the pressure-decreasing linear control valve 67 operate less frequently. This prolongs the service lives of the pressure-increasing linear control valve 66 and the pressure-decreasing linear control valve 67. That is, the durability of each of the pressure-increasing linear control valve 66 and the pressure-decreasing linear control valve 67 is enhanced.

In the embodiment of the invention, because each of the pressure-increasing linear control valve 66 and the pressure-decreasing linear control valve 67 is shared by all the wheel cylinders 23 of the respective wheels, the flow rate of the brake fluid passing through each of these valves is high and the load such as the fluid force applied to each of these valves is large. According to the embodiment of the invention, because the pressure-increasing linear control valve 66 and the pressure-decreasing linear control valve 67 operate less frequently, the durability requirement in a design is mitigated. Therefore, according to the embodiment of the invention, it is possible to enhance the durability of each of the pressure-increasing linear control valve 66 and the pressure-decreasing linear control valve 67, while reducing the production cost by providing only one pressure-increasing linear control valve 66 and only one pressure-decreasing linear control valve 67 that are shared by all the wheel cylinders 23.

Further, the brake ECU 70 may change the control mode to a control mode that differs from the regulator mode, for example, the non-controlled mode. In the non-controlled mode, the brake ECU 70 shuts off the supply of control currents to all the electromagnetically-controlled valves. Therefore, the master cut valve 64 and the regulator cut valve 65, which are the normally-open valves, are opened, and the partition valve 60 and the simulation cut valve 68, which are the normally-closed valves, are closed. The controls over the pressure-increasing linear control valve 66 and the pressure-decreasing linear control valve 67 are terminated and thus these valves are closed. As a result, the brake fluid supply path is partitioned into the two systems, i.e., the master cylinder-side brake fluid supply path and the regulator-side brake fluid supply path. The master cylinder pressure is transferred to the wheel cylinders 23FR and 23FL of the front wheels, and the regulator pressure is transferred to the wheel cylinders 23RR and 23RL of the rear wheels. In the non-controlled mode, a braking force can be generated even if electricity is not supplied to the electromagnetically-controlled valves due to a failure in control systems. Accordingly, sufficient failsafe properties are offered in the non-controlled mode.

As mentioned above, when the control mode is changed from the linear control mode to the regulator control mode, the driver may feel some discomfort in the braking feel. When the regulator cut valve 65 is opened in order to change the control mode to the regulator mode, if the wheel cylinder pressure is higher than the regulator pressure, the brake fluid flows backward from the wheel cylinders 23 to the regulator 33 and the wheel cylinder pressure decreases. If the vehicle is stopped, for example, on a slope, the braking force is decreased due to a decrease in the wheel cylinder pressure, and thus the vehicle may start to move. When the control mode is changed to the regulator mode while the vehicle is decelerating, the braking force is decreased due to a decrease in the wheel cylinder pressure and thus the driver may feel some discomfort in the braking feel.

When the required braking force is obtained only from the hydraulic braking force in the linear control mode, the wheel cylinder pressure is controlled using the regulator pressure as the target pressure. Accordingly, the wheel cylinder pressure corresponds to the regulator pressure, and, basically, the wheel cylinder pressure is supposed to match the regulator pressure. However, under the influence of errors in the measurements by the control pressure sensor 73 and the regulator pressure sensor 71, there is a high probability that the actual wheel cylinder pressure will be controlled to a pressure higher than the regulator pressure. Also, under the influence of control characteristics of a wheel cylinder pressure control system such as the pressure-increasing linear control valve 66, the wheel cylinder pressure may transiently respond to the control to an excessive degree and therefore the wheel cylinder pressure may temporarily overshoot the regulator pressure.

Therefore, according to the embodiment of the invention, the brake ECU 70 changes the control mode from the linear control mode to the regulator mode, when the regulator pressure P_{reg} is equal to or higher than the wheel cylinder pressure P_{fr}. That is, the brake ECU 70 changes the control mode from the linear control mode to the regulator mode when the pressure at the regulator 33-side of the regulator cut valve 65 is higher than the pressure at the wheel cylinder 23-side of the regulator cut valve 65. The brake ECU 70 determines whether the difference P_{reg}-P_{fr} between the regulator pressure P_{reg} and the wheel cylinder pressure P_{fr} is equal to or greater than the threshold value or in order to determine whether the regulator pressure P_{reg} is equal to or higher than the wheel cylinder pressure P_{fr}. If the hydraulic pressure difference P_{reg}-P_{fr} is equal or greater than the threshold value or, the brake ECU 70 determines that the regulator pressure P_{reg} is equal or higher than the wheel cylinder pressure P_{fr}.

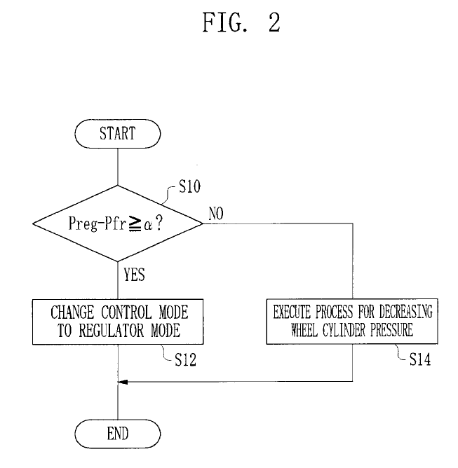

FIG. 2 is a flowchart showing the control routine according to the embodiment of the invention. The brake ECU 70 executes the control routine for changing the control modes, for example, when the vehicle is stopped. Alternatively, the brake ECU 70 may execute this control routine when the vehicle speed is sufficiently decreased by the braking operation and therefore the regenerative braking control is terminated.

When the control routine shown in FIG. 2 is started, first, the brake ECU 70 determines whether the difference P_{reg}-P_{fr} between the regulator pressure P_{reg} and the wheel cylinder pressure P_{fr} is equal to or greater than the threshold value or (S10). The brake ECU 70 uses the value measured by the regulator pressure sensor 71 as the regulator pressure P_{reg}, and the value measured by the control pressure sensor 73 as the wheel cylinder pressure P_{fr}. In the embodiment of the invention, the regulator pressure sensor 71 functions as a manual hydraulic pressure sensor according to the invention.

The threshold value or is determined based on the magnitude of a measurement error in the regulator pressure P_{reg} and the magnitude of a measurement error in the wheel cylinder pressure P_{fr}. The threshold value α may be, for example, the sum of an error in the value measured by the regulator pressure sensor 71 and an error in the value measured by the control pressure sensor 73. When the error in the value measured by the regulator pressure sensor 71 and the error in the value measured by the control pressure sensor 73 are substantially equal to each other, the value obtained by multiplying one of these errors by two may be used as the threshold value α. As an index showing the magnitude of an error, for example, a standard deviation may be used. When the difference P_{reg}-P_{fr} between the regulator pressure P_{reg} and the wheel cylinder pressure P_{fr} is greater than the threshold value α that is set in the above-described manner, it is estimated that the regulator pressure P_{reg} is higher than the wheel cylinder pressure P_{fr} even if each of the regulator pressure P_{reg} and the wheel cylinder pressure P_{fr} includes an error. It is possible to determine more reliably whether the regulator pressure P_{reg} is higher than the cylinder pressure P_{fr}, when the difference P_{reg}-P_{fr} between the regulator pressure P_{reg} and the wheel cylinder pressure P_{fr} is compared with the threshold value α, than when the measured value of the regulator pressure P_{reg} and the measured value of the wheel cylinder pressure P_{fr} are compared to each other.

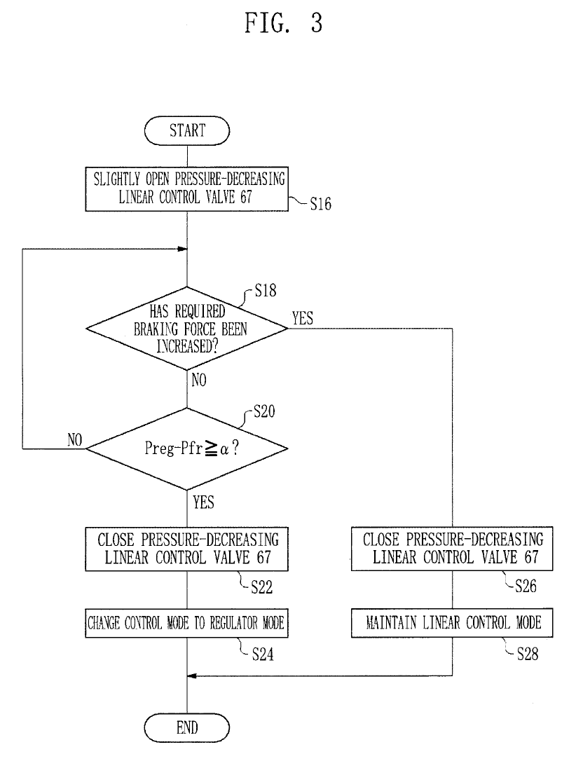

When it is determined that the difference P_{reg}-P_{fr} between the regulator pressure P_{reg} and the wheel cylinder pressure P_{fr} is greater than the threshold value a (“YES” in S10), the brake ECU 70 changes the control mode from the linear control mode to the regulator control mode (S12). On the other hand, when it is determined that the difference P_{reg}-P_{fr} between the regulator pressure P_{reg} and the wheel cylinder pressure P_{fr} is less than the threshold value α (“NO” in S10), the brake ECU 70 executes the process for decreasing the wheel cylinder pressure P_{fr}(S14). In the pressure-decreasing process, the wheel cylinder pressure P_{fr} is gradually reduced so as not to exert a great influence on the vehicle behavior, whereby the regulator pressure P_{reg} is made higher than the wheel cylinder pressure P_{fr}. As described below with reference to FIG. 3, after the wheel cylinder pressure P_{fr} is decreased to a value lower than the wheel cylinder pressure P_{fr}, the brake ECU 70 changes the control mode to the regulator mode. Then, the routine for changing the control modes according to the embodiment of the invention ends.

When it is determined that the difference P_{reg}-P_{fr} between the regulator pressure P_{reg} and the wheel cylinder pressure P_{fr} is less than the threshold value α (“NO” in S10), the brake ECU 70 may maintain the linear control mode without executing the pressure-decreasing process.

FIG. 3 is a flowchart showing the pressure-decreasing routine according to the embodiment of the invention. When the pressure-decreasing routine is started, the brake ECU 70 controls the control current supplied to the pressure-decreasing linear control valve 67 to slightly open the pressure-decreasing linear control valve 67 (S16). The brake ECU 70 sets the opening amount of the pressure-decreasing linear valve 67 to a value at which the vehicle behavior is not influenced by a decrease in the pressure.

Next, the brake ECU 70 determines whether the braking force required by the driver has been increased (S18). More specifically, the brake ECU 70 determines whether the depression amount of the brake pedal 24 has been increased. The brake ECU 70 determines whether the current depression amount is greater than, for example, the depression amount that is detected when the control routine for changing the control modes according to the embodiment of the invention is started.

When it is determined that the required braking force has been increased (“YES” in S18), the brake ECU 70 closes the pressure-decreasing linear valve 67 to stop decreasing the wheel cylinder pressure P_{fr} (S26), and maintains the linear control mode (S28). An increase in the required braking force means that the driver feels some changes in the vehicle behavior and further depresses the brake pedal 24. Accordingly, it is not appropriate to continue decreasing the wheel cylinder pressure P_{fr}. Further, because the linear control mode is maintained, the driver does not feel some discomfort in the braking feel, unlike the case in which the control mode is changed to the regulator mode.

On the other hand, when it is determined that the required braking force has not been increased (“NO” in S18), the brake ECU 70 determines whether the difference P_{reg}-P_{fr} between the regulator pressure P_{reg} and the wheel cylinder pressure P_{fr} is equal to or greater than the threshold value α (S20), as in S10. When it is determined that the difference P_{reg}-P_{fr} between the regulator pressure P_{reg} and the wheel cylinder pressure P_{fr} is equal to or greater than the threshold value α (“YES” in S20), the brake ECU 70 closes the pressure-decreasing linear valve 67 to stop decreasing the pressure (S22), and changes the control mode from the linear control mode to the regulator control mode (S24).

On the other hand, when it is determined that the difference P_{reg}-P_{fr} between the regulator pressure P_{reg} and the wheel cylinder pressure P_{fr} is less than the threshold value α (“NO” in S20), the brake ECU 70 continues decreasing the pressure until it is determined that the difference P_{reg}-P_{fr} between the regulator pressure P_{reg} and the wheel cylinder pressure P_{fr} is equal or greater than the threshold value α. Therefore, a determination as to whether the required braking force has been increased (S18) and a determination as to whether the pressure difference P_{reg}-P_{fr} is greater than the threshold value α (S20) are periodically made until it is determined that the pressure difference P_{reg}-P_{fr} is equal or greater than the threshold value α.

According to the embodiment of the invention, the wheel cylinder pressure is decreased such that the hydraulic pressure upstream of the regulator cut valve 65 is higher than the hydraulic pressure downstream of the regulator cut valve 65, and then the control mode is changed from the linear control mode to the regulator mode. Accordingly, it is possible to reduce discomfort in the braking feel felt by the driver when the control mode is changed. Further, according to the embodiment of the invention, when the required braking force is increased while wheel cylinder pressure is being decreased, the routine for decreasing the wheel cylinder pressure is terminated. Accordingly, it is possible to minimize discomfort in the braking feel while suppressing the influence on the vehicle behavior. More specifically, for example, when the vehicle is stopped on a slope, the vehicle is prevented from moving downward due to a decrease in the wheel cylinder pressure. As a result, the vehicle remains stopped. According to the embodiment of the invention, it is determined whether the regulator pressure P_{reg} is equal to or higher than the wheel cylinder pressure P_{fr} using the threshold value α, which is set with errors in the values measured by the pressure sensors taken into account. Therefore, it is reliably determined whether the regulator pressure P_{reg} is equal to or higher than the wheel cylinder pressure P_{fr}.

According to the embodiment of the invention, the control mode is changed based on the values measured by the pressure sensors. Alternatively, the control mode may be changed based on, for example, the amount by which the driver operates the brake pedal 24. In this case, the brake ECU 70 changes the control modes based on the value measured by the stroke sensor 25. If an error in a value measured by a sensor employed as the stroke sensor 25 is smaller than an error in a value measured by each of the regulator pressure sensor 71 and the control pressure sensor 73, the influence of an error in the measurement by the sensor is minimized when the control mode is changed.

In this case, if the brake pedal 24 is depressed again while the vehicle is stopped, the brake ECU 70 changes the control mode from the linear control mode to the regulator mode. In other words, when the driver releases the brake pedal after the vehicle is stopped, and then depresses the brake pedal again, the brake ECU 70 changes the control mode from the linear control mode to the regulator mode. The brake ECU 70 changes the control mode to the regulator mode in response to the re-depression of the brake pedal 24. When the brake pedal 24 is depressed again as described above, it is estimated that the regulator pressure will be higher than the wheel cylinder pressure. This is because each of the regulator pressure and the wheel cylinder pressure becomes equal to the atmospheric pressure when the brake pedal 24 is released, the regulator pressure is first increased in response to the re-depression of the brake pedal 24, and the wheel cylinder pressure is controlled so as to correspond to the regulator pressure.

The brake ECU 70 may change the control mode from the linear control mode to the regulator mode, when the depression force applied to the brake pedal 24 by the driver has been reduced. If the driver has reduced the depression force on the brake pedal 24, it is considered that the vehicle is stopped on the slope safely without moving downward, etc.

According to the embodiment of the invention, the brake ECU 70 terminates the regulator mode and resumes the linear control mode, when the vehicle starts moving after being once stopped. That is, a braking force after the vehicle starts moving is controlled not in the regulator mode but in the linear control mode.

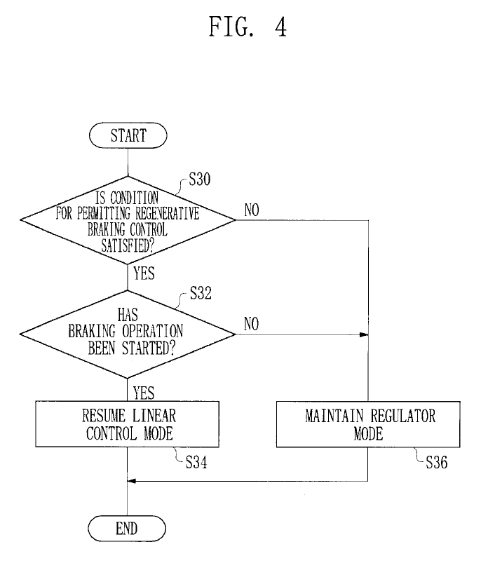

Alternatively, until the regenerative braking control is permitted, the brake ECU 70 may maintain the regulator mode without resuming the linear control mode even after the vehicle starts moving. FIG. 4 is a flowchart showing an example of the routine for resuming the linear control mode according to the embodiment of the invention. In the routine shown in FIG. 4, after it is determined that the regenerative braking control is permitted, the brake ECU 70 changes the control mode from the regulator mode to the linear control mode when the braking operation is performed. When the control mode is the regulator mode, the routine shown in FIG. 4 is executed by the brake ECU 70 at predetermined time intervals.

When the routine is started, the brake ECU 70 determines whether the condition for permitting the regenerative braking control is satisfied (S30). According to the embodiment of the invention, the condition for permitting the regenerative braking control is satisfied when the vehicle speed exceeds a vehicle speed at which the cooperative braking is executed stably, for example, 15 km/h. Alternatively, the condition for permitting the regenerative braking control may be satisfied, for example, when the state of charge of the battery that stores the regenerated energy is below a threshold value.

When it is determined that the condition for permitting the regenerative braking control is satisfied (“YES” in S30), the brake ECU 70 determines whether the braking operation has been started, i.e., whether the brake pedal 24 is depressed to change the braking operation state from the off-state to the on-state (S32). When it is determined that the braking operation has been started (“YES” in S32), the brake ECU 70 terminates the regulator mode and resumes the linear control mode, and controls the braking force in the linear control mode (S34). On the other hand, when it is determined that the condition for permitting the regenerative braking control is not satisfied (“NO” in S30), and it is determined that the braking operation has not been started (“NO” in S32), the brake ECU 70 maintains the regulator mode without resuming the linear control mode (S36).

In this way, the control mode is changed between the regulator mode and the linear control mode less frequently. Especially, if the linear control mode is resumed each time the vehicle starts moving when the braking operation, stopping operation and starting operation are performed frequently, for example, when the vehicle is in a traffic jam, the control mode is frequently changed between the regulator mode and the linear control mode. In contrast, according to the embodiment, the regulator mode is maintained until the condition for permitting the regenerative braking control is satisfied, more specifically, until the vehicle exceeds a predetermined speed. Therefore, the control mode is changed between the regulator mode and the linear control mode less frequently. As a result, noise that may be generated when the control mode is changed is reduced, whereby a quieter brake system is implemented. Frequent changes in the control modes may exert a negative influence on the stability of a brake system. However, according to the embodiment of the invention, the control mode is changed between the regulator mode and the linear control mode less frequently. As a result, the brake system with higher stability is implemented.

While the invention has been shown and described with respect to the example embodiment, it will be understood by those skilled in the art that various changes and modification may be made without departing from the spirit and scope of the invention as defined in the following claims.

What is claimed is:

1. A brake control apparatus, comprising:
a wheel cylinder that applies a braking force to a wheel of a vehicle in response to a supply of a hydraulic fluid to the wheel cylinder;
a wheel cylinder pressure control system that controls a hydraulic pressure applied to the wheel cylinder independently of an operation of a brake pedal;
a manual hydraulic pressure source that pressurizes a hydraulic fluid which is stored in the manual hydraulic pressure source in accordance with an operation amount of the brake pedal;
a hydraulic fluid supply path that connects the manual hydraulic pressure source and the wheel cylinder to each other, that extends in parallel with the wheel cylinder pressure control system, and that is shut off when the hydraulic pressure applied to the wheel cylinder is controlled by the wheel cylinder pressure control system; and
a control unit that executes a control, wherein, in a case where the hydraulic pressure applied to the wheel cylinder is controlled by the wheel cylinder pressure control system such that a hydraulic pressure in the wheel cylinder corresponds to a hydraulic pressure in the manual hydraulic pressure source, when a condition that the hydraulic pressure in the manual hydraulic pressure source is equal to or higher than the hydraulic pressure in the wheel cylinder is satisfied, the control unit terminates the control executed by the wheel cylinder pressure control system, and controls the hydraulic fluid supply path such that the hydraulic fluid is supplied from the manual hydraulic pressure source to the wheel cylinder.

2. The brake control apparatus according to claim 1, further comprising:
a manual hydraulic pressure sensor that detects the hydraulic pressure in the manual hydraulic pressure source; and
a wheel cylinder pressure sensor that detects the hydraulic pressure in the wheel cylinder,
wherein the control unit determines that the condition that the hydraulic pressure in the manual hydraulic pressure source is equal to or higher than the hydraulic pressure in the wheel cylinder is satisfied, when a hydraulic pressure difference, which is obtained by subtracting the hydraulic pressure detected by the wheel cylinder pressure sensor from the hydraulic pressure detected by the manual hydraulic pressure sensor, is equal to or greater than a threshold value.

3. The brake control apparatus according to claim 2, further comprising:
a pressure-decreasing control valve that decreases the hydraulic pressure in the wheel cylinder,
wherein the control unit controls the pressure-decreasing control valve to decrease the hydraulic pressure in the wheel cylinder until it is determined that the hydraulic pressure in the manual hydraulic pressure source is equal to or higher than the hydraulic pressure in the wheel cylinder.

4. The brake control apparatus according to claim 1, wherein
the control unit controls the hydraulic fluid supply path such that the hydraulic fluid is supplied from the manual hydraulic pressure source to the wheel cylinder, when the brake pedal is depressed again while the vehicle is stopped.

5. The brake control apparatus according to claim 1, wherein
the control unit resumes a control mode in which the hydraulic pressure applied to the wheel cylinder is controlled by the wheel cylinder pressure control system, when a condition for permitting a regenerative braking control is satisfied.

6. The brake control apparatus according to claim 1, wherein
a regenerative braking control is able to be executed,
the hydraulic fluid is supplied from the manual hydraulic pressure source to the wheel cylinder while the vehicle is stopped,
the hydraulic pressure applied to the wheel cylinder is controlled by the wheel cylinder pressure control system when the vehicle is moving,
the hydraulic fluid is supplied from the manual hydraulic pressure source to the wheel cylinder when the vehicle starts moving after being once stopped, and
a control mode is changed to a control mode in which the hydraulic pressure applied to the wheel cylinder is controlled by the wheel cylinder pressure control system, when the regenerative braking control is started.

7. The brake control apparatus according to claim 2, wherein
the threshold value is set based on a detection error in the hydraulic pressure in the manual hydraulic pressure source and a detection error in the hydraulic pressure in the wheel cylinder.

8. The brake control apparatus according to claim 1, wherein
the control unit determines whether the hydraulic pressure in the manual hydraulic pressure source is equal to or higher than the hydraulic pressure in the wheel cylinder, when a required braking force has not been increased.

9. The brake control apparatus according to claim 1, wherein
the control unit controls the hydraulic fluid supply path such that the hydraulic fluid is supplied from the manual hydraulic pressure source to the wheel cylinder, when a degree of depression of the brake pedal is reduced.

10. The brake control apparatus according to claim 5, wherein
whether the condition for permitting the regenerative braking control is satisfied is determined based on a vehicle speed or a state of charge of a battery that stores regenerated energy.

11. The brake control apparatus according to claim 1, wherein
the wheel cylinder pressure control system includes a normally-closed control valve, and
the control unit shuts off a supply of control current to the normally-closed control valve, thereby controlling the hydraulic fluid supply path such that the hydraulic fluid is supplied from the manual hydraulic pressure source to the wheel cylinder.

12. A brake control method that changes a control mode between a control mode in which a hydraulic pressure applied to a wheel cylinder is controlled by a wheel cylinder pressure control system and a control mode in which a hydraulic fluid is supplied from a manual hydraulic pressure source to the wheel cylinder, comprising:
determining whether a hydraulic pressure in the manual hydraulic pressure source is equal to or higher than a hydraulic pressure in the wheel cylinder; and
changing the control mode from the control mode in which the hydraulic pressure applied to the wheel cylinder is controlled by the wheel cylinder pressure control system to the control mode in which the hydraulic fluid is supplied from the manual hydraulic pressure source to the wheel cylinder, when it is determined that the hydraulic pressure in the manual hydraulic pressure source is equal to or higher than the hydraulic pressure in the wheel cylinder while the hydraulic pressure applied to the wheel cylinder is controlled by the wheel cylinder pressure control system.

13. The brake control method according to claim 12, wherein.
when it is determined that the hydraulic pressure in the manual hydraulic pressure source is lower than the hydraulic pressure in the wheel cylinder, the control mode in which the hydraulic pressure applied to the wheel cylinder is controlled by the wheel cylinder pressure control system is maintained.

14. The brake control method according to claim 13, wherein,
when it is determined that the hydraulic pressure in the manual hydraulic pressure source is lower than the hydraulic pressure in the wheel cylinder, a process for decreasing the hydraulic pressure in the wheel cylinder is executed.

15. The brake control method according to claim 14, wherein
the process for decreasing the hydraulic pressure in the wheel cylinder comprises:
controlling control current supplied to a pressure-decreasing control valve included in the wheel cylinder pressure control system to open the pressure-decreasing control valve.

16. The brake control method according to claim 15, wherein
when it is determined that the required braking force has been increased, the pressure-decreasing control valve is closed and the control mode in which the hydraulic pressure applied to the wheel cylinder is controlled by the wheel cylinder pressure control system is maintained.

17. The brake control method according to claim 15, wherein
when it is determined that the required braking force has not been increased and the hydraulic pressure in the manual hydraulic pressure source is lower than the hydraulic pressure in the wheel cylinder, the pressure-decreasing control valve is controlled to decrease the hydraulic pressure in the wheel cylinder until the hydraulic pressure in the manual hydraulic pressure source is equal to or higher than the hydraulic pressure in the wheel cylinder.

18. The brake control method according to claim 12, wherein
when a condition for permitting a regenerative braking control is satisfied, the control mode in which the hydraulic pressure applied to the wheel cylinder is controlled by the wheel cylinder pressure control system is resumed.

19. The brake control method according to claim 12, wherein
a regenerative braking control is able to be executed,
the hydraulic fluid is supplied from the manual hydraulic pressure source to the wheel cylinder while a vehicle is stopped,
the hydraulic pressure applied to the wheel cylinder is controlled by the wheel cylinder pressure control system when the vehicle is moving,
the hydraulic fluid is supplied from the manual hydraulic pressure source to the wheel cylinder when the vehicle starts moving after being once stopped, and
the control mode is changed to the control mode in which the hydraulic pressure applied to the wheel cylinder is controlled by the wheel cylinder pressure control system, when the regenerative braking control is started.
